(19) United States
(12) Patent Application Publication
(10) Pub. No.: US 2016/0150877 A1
(43) Pub. Date: Jun. 2, 2016

(54) TELESCOPIC LEG STRUCTURE OF TABLE

(71) Applicant: CHINGDAR ENTERPRISE CO., LTD., New Taipei City (TW)

(72) Inventor: JHEN-SIANG WEI SIAO, TAIPEI CITY (TW)

(21) Appl. No.: 14/556,429

(22) Filed: Dec. 1, 2014

(51) Int. Cl. A47B 9/20; F16B 7/14

(52) U.S. Cl. CPC A47B 9/20; F16B 7/1472

(57) ABSTRACT

A telescopic leg structure of table is disclosed, comprising at least one inner tube inserted into at least one outer tube, an opening on the inner tube wall along with a longitudinal axle of the inner tube, at least one locking element inserted into the inner tube and having a screw hole facing the opening of the inner tube, and at least one fastening element inserted into a hole of the outer tube and bolted to the screw hole of the locking element.

### BACKGROUND OF THE INVENTION

1. Field of the Invention

The present invention relates a telescopic leg structure of table. More particularly, a telescopic leg structure of table could avoid forming unaesthetic indentation on an external wall of an inner tube.

2. Description of Related Art

The traditional table leg is fixed length and the height of the traditional table could not be adjusted according to the user, so it is inconvenient for personal use and the space use. Because the heights of the table and the user are unsuited, the sitting position of the user is affected to cause the problem such as muscular soreness.

Therefore, the table manufacturers have researched every kind of the adjustable telescopic leg structure. The inventor of the present invention has published the U.S. Pat. No. 7,293,510, “Telescopic leg structure of a table”. An improvement on a telescopic leg of a table comprises an outer tubular member and an inner tubular member. The top of the outer tubular member is coupled to a desktop and covers the outside of the inner tubular member. The outer tubular member also has a bolt hole, and two first protruding portions are formed on the internal wall of the inner tubular tube adjacent to the both sides of the bolt hole, and a first fitting space is formed adjacent to the bolt hole. Two second fitting spaces on external walls of the inner tubular member are opposite the first protruding portions, and two second protruding portions are extended from the second fitting spaces to opposite the first fitting spaces. Furthermore, the first protruding portions are fitted in the second fitting spaces, and the second protruding portions are fitted in the first fitting spaces. Therefore, the inner tubular to member and the outer tubular member are embedded with each other, and then a fixing bolt is engaged with the bolt hole and the end of the fixing bolt is pressed against to the inner tubular member for positioning.

The U.S. Pat. No. 7,293,510 “Telescopic leg structure of a table”, which invented by the inventor of the present invention, applied a structure design that the height of table legs could be adjusted, in which the outer tubular member and the inner tubular member are coupled by the design of the first protruding portions, the first fitting spaces, the second protruding portions, and the second fitting spaces. When the fixing bolt is pressed against the inner tubular member, the second protruding portions and the second fitting spaces of the inner tubular member are embedded with the first fitting spaces and the first protruding portions of the outer tubular member, and the contact between them is surface contact so as to make well stability of the table leg. However, the matches among the first protruding portions and the first fitting spaces of the outer tubular member and the second protruding portions and the second fitting spaces of the inner tubular member should be designed in high accuracy, so it causes the higher manufacture cost and the more difficult in form, resulting in easily producing the defective production. In addition, the fixing bolt used to fix the outer tubular member and the inner tubular member is pressed against the external wall of the inner tubular member to make the shape of the inner change, so the second protruding portions and the second fitting spaces are closely contacted with the first protruding portions and the first fitting spaces. Therefore, after the use, the external wall of the inner tubular member has an indentation caused by the press from the end of the fixing bolt. When the user changes the different height of the table, the indentation at the previous position of the external wall of the inner tubular member is exposed to create an unaesthetic appearance so as to indirectly affect the user desire to buy and the sales.

### SUMMARY OF THE INVENTION

Therefore, the object of the present invention is to provide a telescopic leg structure of table for avoiding forming unaesthetic indentation caused by screwing on an external wall of an inner tube.

For the above object, a telescopic leg structure of table is disclosed, comprising at least one outer tube, at least one inner tube, an opening, at least one locking element, and at least one fastening element. At least one hole is formed on the outer tube wall and communicated with an inside of the outer tube. The inner tube is inserted into the inside of the outer tube. The opening is on the inner tube wall along with a longitudinal axle of the inner tube and opposite the hole of the outer tube. The locking element is inserted into an inside of the inner tube and having a screw hole facing the opening of the inner tube. The fastening element is inserted into the hole of the outer tube and bolted to the screw hole of the locking element.

According to an embodiment of the present invention, the telescopic leg structure of table further comprises two flanges and two is positioning blocks. The two flanges are folded inward the inside of the inner tube adjacent to the both sides of the opening respectively, and the two flanges and the both side walls of the inner tube define a positioning groove respectively. The two positioning blocks are projected from the both sides of the locking element respectively and are embedded in the two positioning grooves respectively.

According to an embodiment of the present invention, the telescopic leg structure of table further comprises a connect tube to connect the tops of two of the outer tubes together.

According to an embodiment of the present invention, the telescopic leg structure of table further comprises a foot cap assembled on the bottom of the inner tube for avoiding skidding.

Therefore, when the telescopic leg structure of table is used by the user, the fastening element is bolted to the locking element, thereby sequentially pressing the locking element, the inner tube, and the outer tube against one another to steadily position the outer and the inner tube. The locking element of the present invention is set in the inside of the inner tube for firmly positioning the inner and the outer tube, thereby is avoiding forming unaesthetic indentation on the external wall of the inner tube to attract the consumer to buying so as to increase sales. Furthermore, in the structure design, the connection structures among the locking element, the inner tube, and the outer tube do not need high accuracy, so the manufacture cost is decreased and the defective rate is also decreased. Under the increase of the sales and the decrease of the manufacture cost and the defective rate, it effectively increases more competitive in the industry.

### BRIEF DESCRIPTION OF THE DRAWINGS

FIG. 1 is an exploded view of a telescopic leg structure of table according to the embodiment of the present invention;

FIG. 2 is a perspective view of a telescopic leg structure of table according to the embodiment of the present invention;

FIG. 3 is a partial sectional view of a telescopic leg structure of table according to the embodiment of the present invention;

FIG. 4 is a horizontal sectional view of a telescopic leg structure of table according to the embodiment of the present invention;

FIG. 5 is a perspective view of a desktop coupled to telescopic leg structures according to the embodiment of the present invention; and

FIG. 6 is a horizontal sectional view of a telescopic leg structure of table when it is used according to the embodiment of the present is invention.

### DETAILED DESCRIPTION OF THE PREFERRED EMBODIMENT

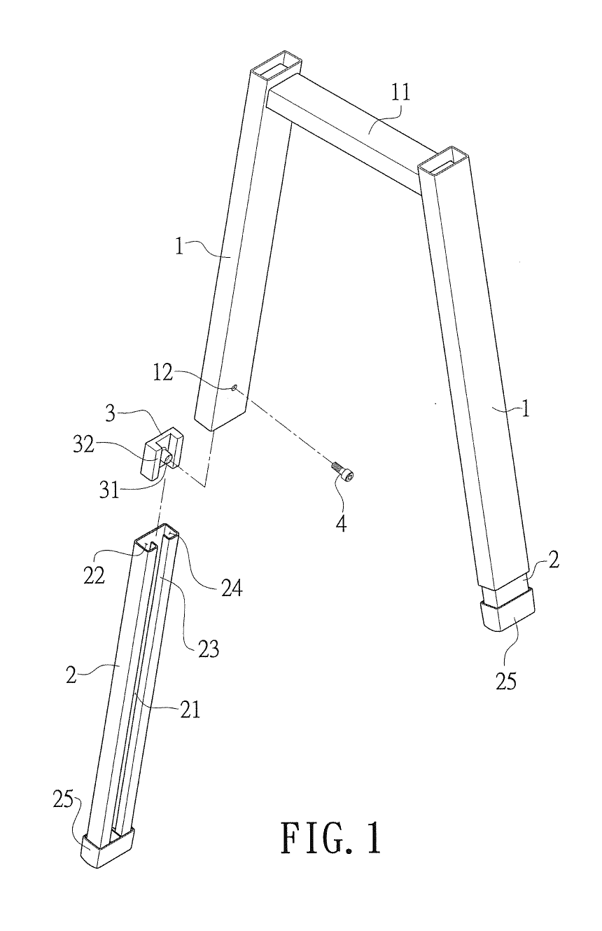

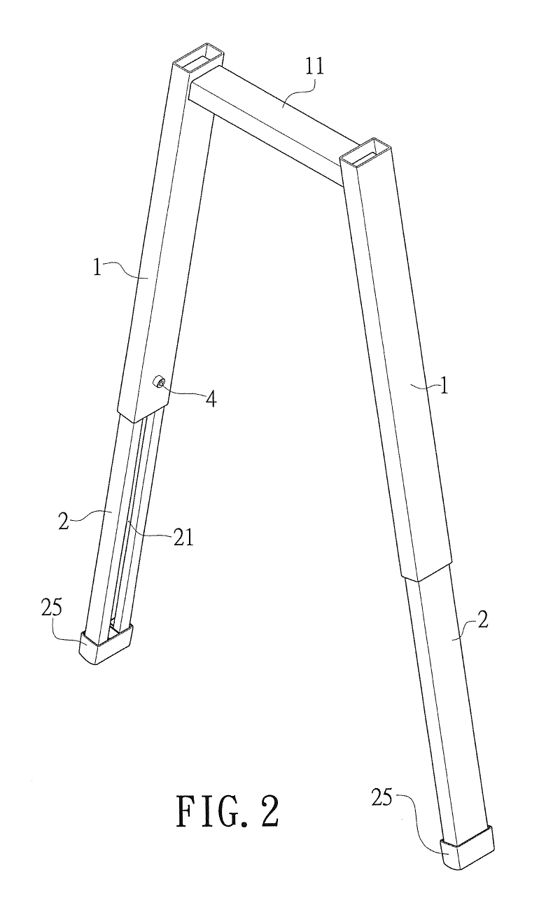

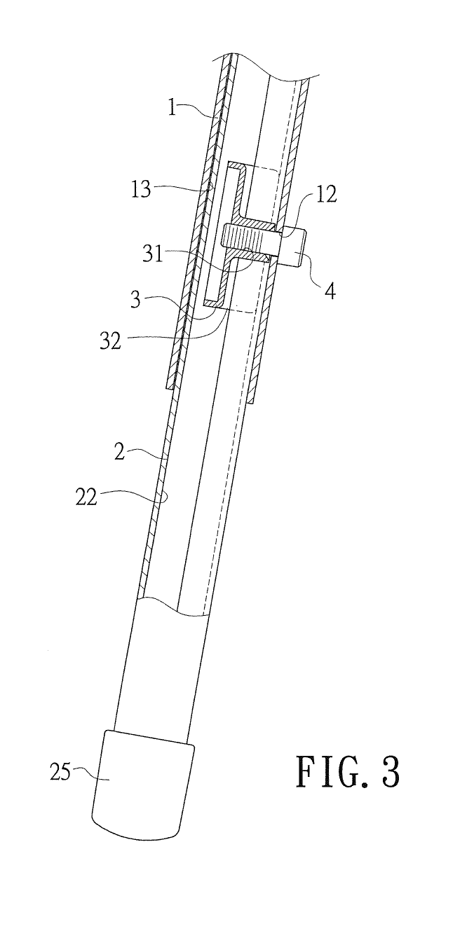

Please refer to FIG. 1 to FIG. 4. The telescopic leg structure of table of the present invention comprises at least one outer tube 1, at least one inner tube 2, at least one locking element 3, and at least one fastening element 4.

In an embodiment, the telescopic leg structure of table comprises two outer tubes 1 opposite each other and a connect tube 11 for connecting the tops of the outer tubes 1. At every outer tube, the center of the outer tube wall has at least one hole 12 to communicate with an inside 13 of the outer tube 1.

The inner tubes 2 are inserted into the inside 13 of the outer tubes 1 respectively. The center of the inner tube wall has an opening 21 along with a longitudinal axle of the inner tube 2, and the opening 21 is communicated with an inside 22 of the inner tube 2 and opposite the hole 12 of the outer tube 1. Two flanges 23 are folded inward the inside 22 of the inner tube 2 adjacent to the both sides of the opening 21 respectively, and the two flanges 23 and the both side walls of the inside 22 of the inner tube 2 define a positioning groove 24 respectively. Furthermore, a is foot cap 25 is assembled on the bottom of the inner tube 2 for avoiding skidding.

The inside 22 of every inner tube 2 is inserted with the locking element 3 respectively and the locking element 3 have a screw hole 31 facing the opening 21 of the inner tube 2. Two positioning blocks 32 are projected from the both sides of the screw hole 31 of the locking element 3 respectively and are embedded in the two positioning grooves 24 of the inner tube 2 respectively.

In an embodiment, the telescopic leg structure of table comprises two fastening elements 4. The fastening elements 4 are screws or bolts. The two fastening elements 4 are inserted into the holes 12 of the two outer tubes 1 respectively and bolted to the screw hole 31 of the locking element 3 to fasten the locking element 3, thereby pressing the two positioning blocks 32 of the locking element 3 against the walls of the positioning grooves 24 of the inner tube 2 so as to press the inner tube 2 against the wall of the inside 13 of the outer tube 1.

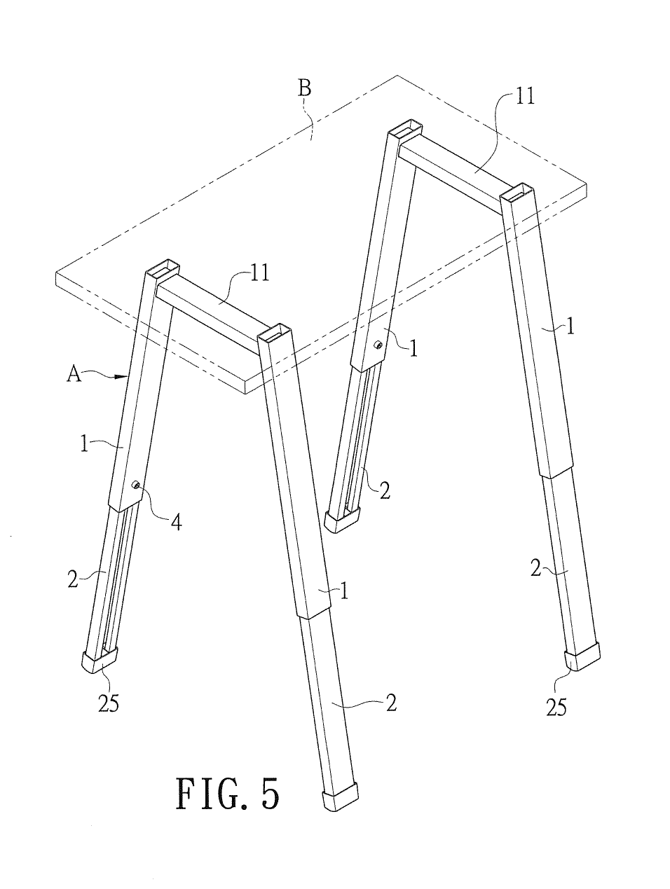

Please refer to FIG. 5, showing a perspective view of a desktop coupled to telescopic leg structures according to the embodiment of the present invention. When the telescopic leg structure of table is coupled to the desktop, the two sets of the telescopic leg structure A of table of the present invention are installed under the desktop B and fixed with the desktop B by fastening elements via the connect tube 11.

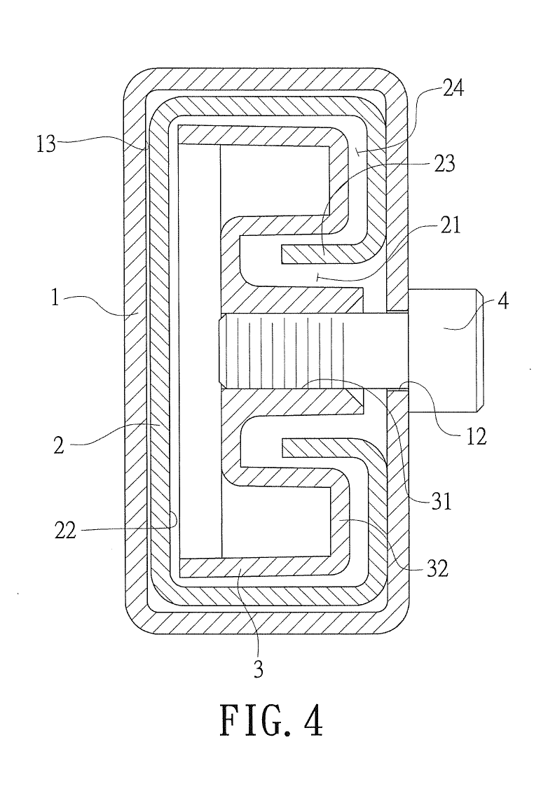

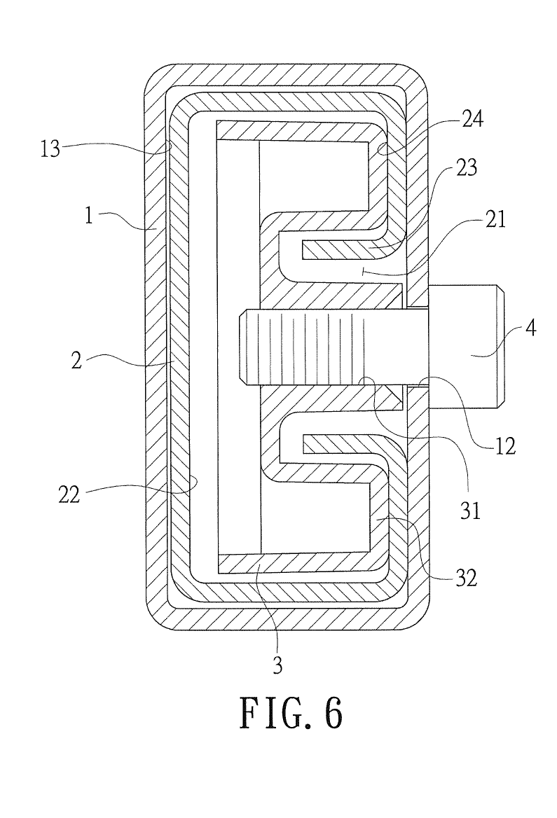

Please refer to FIG. 4, showing a horizontal sectional view of a telescopic leg structure of table according to the embodiment of the present invention. When the user wants to adjust the height of the desktop B, the fastening element 4 is released to relieve the press against the inner tube 2 and the outer tube 1 by the locking element 3. Therefore, the inner tube 2 is relative to the outer tube 1 to move to adjust the length of the inner tube 2 extending from the outer tube 1. Please refer to FIG. 6, showing a horizontal sectional view of a telescopic leg structure of table when it is used according to the embodiment of the present invention. When the desired length of the inner tube 2 extending from the outer tube 1 is set, the fastening element 4 is locked and then fastens the locking element 3 by bolting with the screw hole 31 of the locking element 3, thereby pressing the two positioning blocks 32 of the locking element 3 against the walls of the positioning grooves 24 of the inner tube 2 further to press the inner tube 2 against the walls of the inside 13 of the outer tube 1 for firmly positioning the inner tube 2 and the outer tube 1. Because the contact among the locking element 3, the inner tube 2, and the outer tube 1 is surface contact, the friction among them could be doubled increased so as to raise the stability of the table leg after the locking element 3, the inner tube 2, and the outer tube 1 are fixed together.

Therefore, the telescopic leg structure of table of the present invention does not form unaesthetic indentation caused by screwing the fastening element 4 at the external wall of the inner tube 2 to influence the customer's desire to purchase and the sales. Furthermore, in the structure design, the connection structures among the locking element, the inner tube, and the outer tube do not need high accuracy, so the manufacture cost is decreased, the ease of production is increased, and the defective rate is also decreased. Therefore, under the increase of the sales and the decrease of the manufacture cost and the defective rate, it effectively increases more competitive in the industry.

According to the above description and embodiments, the telescopic leg structure of table in the present invention has the advantages as following:

1. In the telescopic leg structure of table of the present invention, the fastening element is utilized to bolt to the locking element, thereby sequentially pressing the locking element against the inner tube, and then the inner tube is pressed against the outer tube to steadily position the outer and the inner tube. Furthermore, the locking element is set in the inside of the inner tube and the contact between the locking element and the inner tube is surface contact, so it avoids forming unaesthetic indentation caused by pressing the single point on the external wall of the inner tube. Therefore, it could attract the consumer to buying the telescopic leg structure of table of the present invention so as to increase sales.

2. In the telescopic leg structure of table of the present invention, the locking element is inserted into the inner tube and the inner tube is inserted to the outer tube, and then the fastening element is utilized to bolt to the locking element via the outer tube and the inner tube for firmly and sequentially positioning the locking element, the inner tube, and the outer tube. Therefore, there does not need high accuracy in the structure design so as to not only decrease the manufacture cost, but also increase the ease of production and decrease of the defective rate, thereby further increasing more competitive in the industry.

Additional advantages and modifications will readily occur to those skilled in the art. Therefore, the invention in its broader aspects is not limited to the specific details, and representative structures or devices shown and described herein. Accordingly, various modifications may be made without departing from the spirit or scope of the general inventive to concept as defined by the appended claims and their equivalents.

What is claimed is:

1. A telescopic leg structure of table, comprising:
at least one outer tube, having at least one hole on the outer tube wall to communicate with an inside of the outer tube;
at least one inner tube, inserted into the inside of the outer tube;
an opening, on the inner tube wall along with a longitudinal axle of the inner tube and communicated with an inside of the inner tube, wherein the opening is opposite the hole of the outer tube;
at least one locking element, inserted into the inside of the inner tube and having a screw hole facing the opening of the inner tube; and
at least one fastening element, inserted into the hole of the outer tube and bolted to the screw hole of the locking element.

2. The telescopic leg structure of table according to claim 1, further comprising:
two flanges, folded inward the inside of the inner tube adjacent to the both sides of the opening respectively, wherein the two flanges and the both side walls of the inner tube define a positioning groove respectively; and
two positioning blocks, projected from the both sides of the locking element respectively and embedded in the two positioning grooves respectively.
